(19) United States
(12) Patent Application Publication
(10) Pub. No.: US 2026/0057346 A1
(43) Pub. Date: Feb. 26, 2026

(54) COMPUTER SYSTEMS, METHODS, AND NON-TRANSITORY COMPUTER-READABLE STORAGE DEVICES FOR PROJECT MANAGEMENT

(71) Applicant: ROYAL BANK OF CANADA, Toronto (CA)

(72) Inventors: Jacob Behara, Toronto (CA); Akshay Desale, Toronto (CA); Clara Hou, Toronto (CA); Richard Li, Sarnia (CA)

(21) Appl. No.: 19/302,834

(22) Filed: Aug. 18, 2025

Related U.S. Application Data
(60) Provisional application No. 63/685,346, filed on Aug. 21, 2024.

(51) Int. Cl. G06Q 10/10; G06Q 10/0637; G06Q 10/0639

(52) U.S. Cl. CPC G06Q 10/103; G06Q 10/0637; G06Q 10/06393

(57) ABSTRACT

Computer systems, apparatuses, processors, and non-transitory computer-readable storage devices configured for executing a method comprising performing process mining on user log data; translating results of the process mining into actionable insights using a machine learning engine; and providing an option to convert the actionable insights into one or more tickets for a product management team.

### CROSS-REFERENCE TO RELATED APPLICATIONS

This application claims priority to U.S. Provisional Application No. 63/685,346, entitled “COMPUTER SYSTEMS, METHODS, AND NON-TRANSITORY COMPUTER-READABLE STORAGE DEVICES FOR PROJECT MANAGEMENT”, filed Aug. 21, 2024, which is hereby incorporated by reference in its entirety.

### TECHNICAL FIELD

The present disclosure relates generally to computer systems, methods, and non-transitory computer-readable storage devices, and in particular to computer systems, methods, and non-transitory computer-readable storage devices for project management.

### BACKGROUND

A large enterprise such as a financial institution can have an enormous amount of log data, stored on numerous systems in various locations. Such log data can be valuable information in assisting in the management and improvement of projects and processes of the enterprise. However, the volume and complexity of the log data make it logistically difficult for the enterprise teams to make effective use. Some tools and methods exist in processing event log data, but existing solutions are often lacking in the ability to present results to use with ease and can be seen as a high entry barrier for end users.

Therefore, there is a desire for a project management system and method that can process log data to better address the needs of the enterprise.

### SUMMARY

According to one aspect of this disclosure, there is provided a computerized method comprising performing process mining on user log data; translating results of the process mining into actionable insights using a machine learning engine; and providing an option to convert the actionable insights into one or more tickets for a product management team.

In some embodiments, the computerized method further comprises prioritizing the one or more tickets for the product management team using a classification machine learning model.

In some embodiments, said prioritizing the one or more tickets comprises generating a score associated with each of the one or more tickets; and ranking the one or more tickets based on their generated scores.

In some embodiments, said generating a score associated with each of the one or more tickets comprises comparing names of the one or more tickets to the generated actionable insights; and assigning the score to each ticket based on a number of matched keywords contained in each ticket, wherein the matched keywords comprise words that match with the actionable insights and exclude stop words.

In some embodiments, said translating results of the process mining into actionable insights using a machine learning engine comprises converting a graph generated by the process mining into prompts for the machine learning engine.

In some embodiments, the graph comprises a Sankey diagram representing flows between user behaviors.

In some embodiments, said performing process mining on user log data comprises using a pm4py library to analyze user behaviors from the user log data to create a graph.

In some embodiments, the computerized method further comprises upon user selection to convert the actionable insights into the one or more tickets, populating the one or more tickets based on a machine learning model trained on previous tickets generated by the product management team.

In some embodiments, said populating the one or more tickets comprises a Retrieval Augmented Generation (RAG) implementation.

According to one aspect of this disclosure, there are provided one or more processors for performing the above-described method.

According to one aspect of this disclosure, there are provided one or more non-transitory computer-readable storage devices comprising computer-executable instructions, wherein the instructions, when executed, cause one or more processing units to perform the above-described method.

According to one aspect of this disclosure, there is provided a system comprising one or more processors; and one or more non-transitory computer-readable storage media functionally coupled to the one or more processors and storing instructions that, when executed, cause the one or more processors to: perform process mining on user log data; translate results of the process mining into actionable insights using a machine learning engine; and provide an option to convert the actionable insights into one or more tickets for a product management team.

In some embodiments, the instructions further cause the one or more processors to prioritize the one or more tickets for the product management team using a classification machine learning model.

In some embodiments, said prioritizing the one or more tickets comprises: generating a score associated with each of the one or more tickets; and ranking the one or more tickets based on their generated scores.

In some embodiments, said generating a score associated with each of the one or more tickets comprises comparing names of the one or more tickets to the generated actionable insights; and assigning the score to each ticket based on a number of matched keywords contained in each ticket, wherein the matched keywords comprise words that match with the actionable insights and exclude stop words.

In some embodiments, said translating results of the process mining into actionable insights using a machine learning engine comprises converting a graph generated by the process mining into prompts for the machine learning engine.

In some embodiments, the graph comprises a Sankey diagram representing flows between user behaviors.

In some embodiments, said performing process mining on user log data comprises using a pm4py library to analyze user behaviors from the user log data to create a graph.

In some embodiments, the instructions further cause the one or more processors to: upon user selection to convert the actionable insights into the one or more tickets, populate the one or more tickets based on a machine learning model trained on previous tickets generated by the product management team.

In some embodiments, said populating the one or more tickets comprises a Retrieval Augmented Generation (RAG) implementation.

According to one aspect of this disclosure, there is provided a non-transitory computer-readable storage medium storing instructions that, when executed by one or more processors, cause the one or more processors to perform operations comprising performing process mining on user log data; translating results of the process mining into actionable insights using a machine learning engine; and providing an option to convert the actionable insights into one or more tickets for a product management team.

In some embodiments, the operations further comprise prioritizing the one or more tickets for the product management team using a classification machine learning model.

This summary does not necessarily describe the entire scope of all aspects. Other aspects, features and advantages will be apparent to those of ordinary skill in the art upon review of the following description of specific embodiments.

### BRIEF DESCRIPTION OF THE DRAWINGS

In the accompanying drawings, which illustrate one or more example embodiments:

FIG. 1 depicts a computer network system according to some embodiments of this disclosure;

FIG. 2 is a block diagram of a server of the computer network system shown in FIG. 1;

FIG. 3 is an architecture diagram of the computer network system shown in FIG. 1, according to an exemplary embodiment of this disclosure;

FIG. 4 is a process flow diagram of the computer network system, according to some embodiments of this disclosure;

FIG. 5 is a flowchart showing the steps at the user end, according to some embodiments of this disclosure;

FIG. 6 is a flowchart showing the steps of a method performed by the computer network system, according to some embodiments of this disclosure;

FIG. 6A is a flowchart showing the steps of a method performed by the computer network system, according to some embodiments of this disclosure;

FIG. 7 is an example of an output graph of process mining, according to some embodiments of this disclosure;

FIG. 8 is an example of an insight, according to some embodiments of this disclosure;

FIG. 9 is an example of a result of the Large Language Model (LLM) for generating a ticket, according to some embodiments of this disclosure;

FIG. 10 is an example of a portion of a user interface providing recommendations with options to generate tickets;

FIG. 11 is an example of a portion of a user interface providing a graph of the behavior path;

FIG. 12 is an example of a portion of a user interface providing backlog prioritization.

### DETAILED DESCRIPTION

Embodiments disclosed herein relate to methods, systems, and techniques for processing log-based user data to provide actionable insights and recommendations for use of an enterprise product management team. Various embodiments disclosed herein integrate insights and recommendations with at least one project management tool to ensure seamless transition from recommendation to team's workflow. One aspect of the disclosure further relates to methods, systems, and techniques for prioritizing the product management team's backlog.

The methods, systems, and techniques disclosed herein use one or more artificial intelligence (AI) engines and models such as machine learning (ML) engines and models to integrate with one or more of the processes of processing mining, insights generation, and/or backlog prioritization.

In some embodiments, the system disclosed herein comprises one or more backend processing modules that process a large quantity of ingested log-based user data (in the scale of terabytes) through process mining to generate actionable insights and recommendations.

In some embodiments, the system disclosed herein also comprises one or more front end modules for providing one or more user interfaces for insights, recommendations, and/or actionable tickets to facilitate the product management team to make better data-driven decisions.

In some embodiments, the system disclosed herein provides interfaces with one or more ML engines (e.g., a Large Language Model (LLM) engine) and one or more project management (PM) tools to provide a centralized, integrated pipeline.

In some embodiments, the methods, systems, and techniques disclosed herein further prioritize the tasks, issues and/tickets using a classification ML model.

As those skilled in the art will understand, due to the complexity of the Al engines and models, the large number and distributed nature of log data, and the large amount of data for training the AI models, the AI-based methods disclosed herein cannot be manually performed and a computer system is generally required.

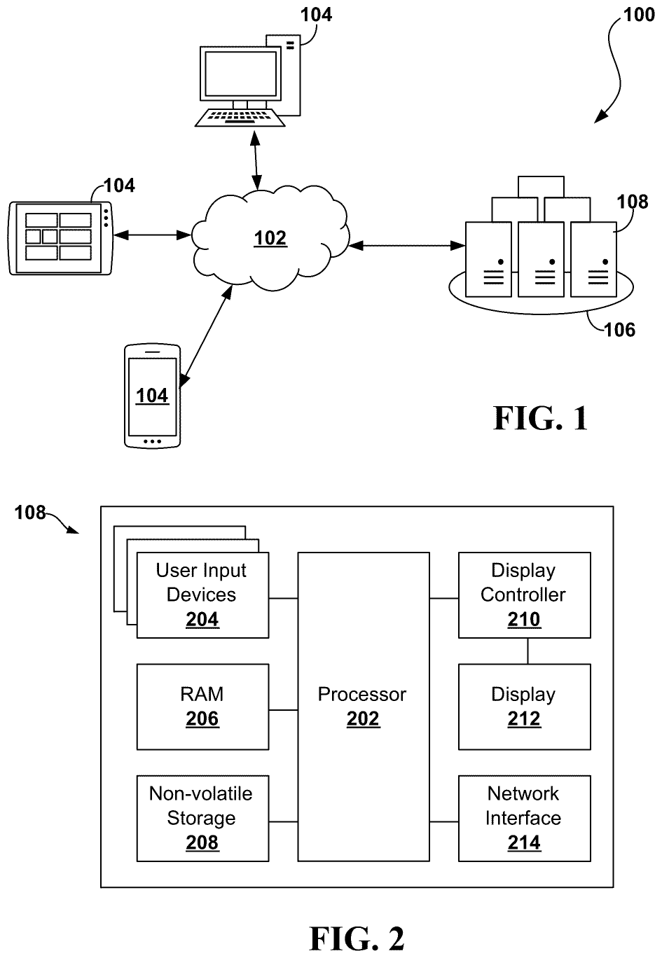

Embodiments are described below, by way of example only, with reference to FIGS. 1-12.

Referring now to FIG. 1, there is shown a computer network system 100 that comprises an example embodiment of a system for project and process management.

As shown in FIG. 1, the computer network system 100 comprises a network 102 such as a wide area network 102 (for example, the Internet) to which various user devices 104, and data center 106 are communicatively coupled. The data center 106 comprises one or more servers 108 networked together to collectively perform various computing functions. For example, in the context of a financial institution such as a bank, the data center 106 may host online banking services that permit users to log in to servers 108 thereof using user accounts that give them access to various computer-implemented services. These various computer-implemented services can be categorized generally into various lines of business (LOBs), including but not limited to retail, banking and financial service (BFS), advice center, contact center, operations, risk, or the like. In some implementations, the data center 106 can be hosted in a cloud service environment and/or an on-premises service environment.

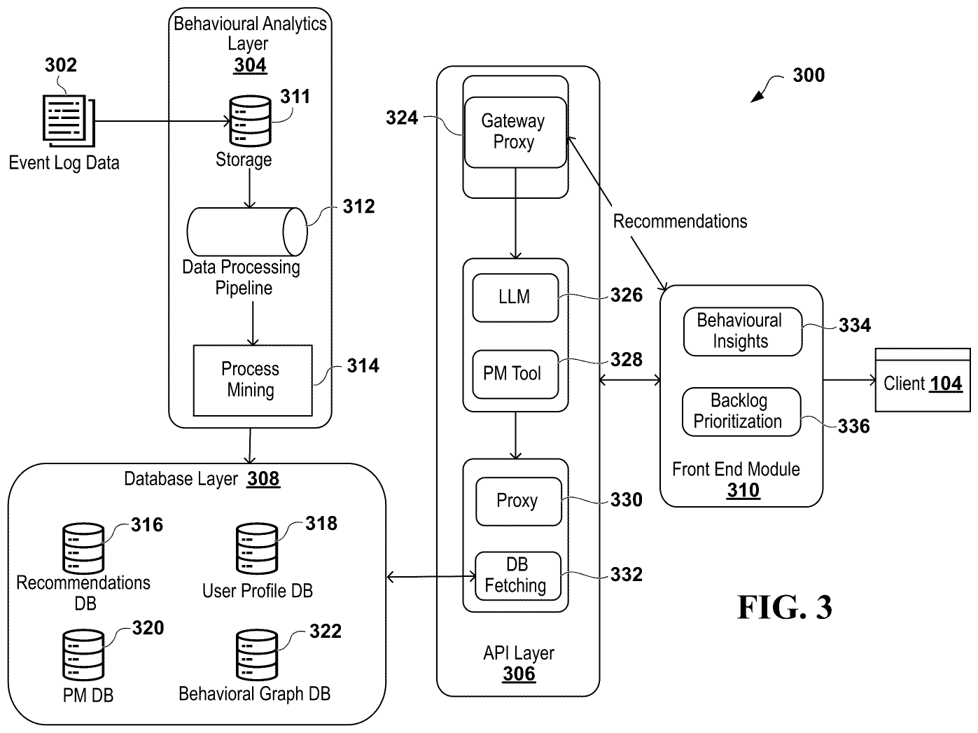

Referring now to FIG. 2, there is depicted an example embodiment of one of the servers 108 of the data center 106. The server 108 comprises one or more processors 202 that control the server's overall operation. The one or more processors 202 are communicatively coupled to and control several subsystems. These subsystems comprise one or more user input devices 204, which may comprise, for example, any one or more of a keyboard, mouse, touch screen, voice control, and/or the like; one or more non-transitory computer-readable storage devices or media 206 such as random access memory (“RAM”), which store computer-executable instructions or program code for execution at runtime by the processor 202; non-transitory, non-volatile, computer-readable storage devices or media 208, which store the computer-executable instructions or program code executed by the RAM 206 at runtime; a display controller 210, which is communicatively coupled to and controls a display 212; and a network interface 214, which facilitates network communications with the wide area network 102 and the other servers 108 in the data center 106. The non-volatile storage 208 has stored on it computer program code that is loaded into the RAM 206 at runtime and that is executable by the processor 202. When the computer program code is executed by the processor 202, the processor 202 causes the server 108 to implement a method for analyzing various log-based user data for providing actionable insights and recommendations (described in more detail below), and the processor 202 may further cause the server 108 to implement a method for prioritization of a product management team's backlogs (also described in more detail below). Additionally or alternatively, the servers 108 may collectively perform these methods using distributed computing frameworks. While the system depicted in FIG. 2 is described specifically in respect of one of the servers 108, analogous versions of the system may also be used for the user devices 104.

The processor 202 used in the foregoing embodiments may comprise, for example, a processing unit (such as one or more processors, microprocessors, or programmable logic controllers) or one or more microcontrollers (which comprise both one or more processing units and one or more non-transitory computer readable media). Examples of computer readable media that are non-transitory include disc-based media such as CD-ROMs and DVDs, magnetic media such as hard drives and other forms of magnetic disk storage, semiconductor based media such as flash media, random access memory (including DRAM and SRAM), and read only memory. As an alternative to an implementation that relies on processor-executed computer program code, a hardware-based implementation may be used. For example, an application-specific integrated circuit (ASIC), field programmable gate array (FPGA), system-on-a-chip (SoC), or other suitable type of hardware implementation may be used as an alternative to or to supplement an implementation that relies primarily on a processor executing computer program code stored on a computer medium.

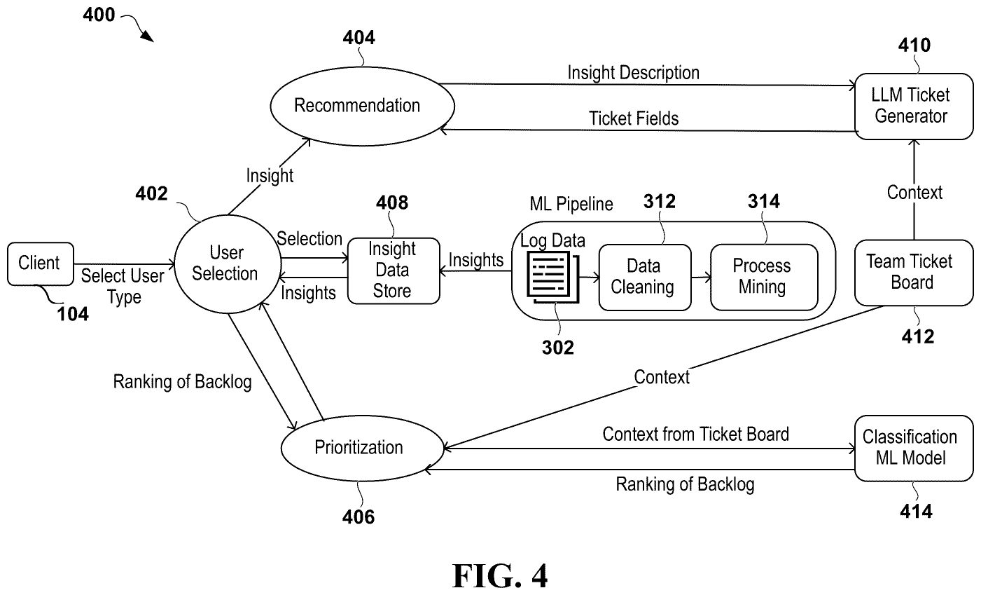

FIG. 3 is an architecture block diagram 300 of the computer network system 100, according to an exemplary embodiment of this disclosure.

As depicted in the exemplary embodiment of FIG. 3, the computer network system 100 comprises a behavior analytics module 304, an application programming interface (API) layer 306, a database layer 308, and a front end module 310. Each of these modules 304-336 can comprise one or more sub modules. In various embodiments disclosed herein, the modules 304-336 leverage one or more ML models in deriving actionable insights from ingested log data 302 (e.g., event log data). The actionable insights can be presented to a user at a client device 104 through e.g., a web application.

In some embodiments, the behavioral analytics module 304 comprises at least one storage 311, a data processing pipeline 312 and a process mining module 314, as will be described in more detail below.

In some embodiments, the database layer 308 comprises one or more databases, including but not limited to a recommendation database 316, a user profile database 318, a project management (PM) database 320, and a behavioral graph database 322. The databases can take any suitable structure for organizing data. For example, while shown as separate individual databases, some or all of the databases may be integrated. Furthermore, one or more of the databases may each be implemented as an ensemble of a plurality of related databases. By way of an example, the behavioral graph database 322 may comprise an additional graph modes database and an additional graph links database.

In some embodiments, the API layer 306 comprises one or more external or internal APIs interfacing one or more external or internal modules. For example, the API layer 306 can comprise a gateway proxy 324 to a ML engine (via a ML API 326). The ML engine can be an external LLM engine including but not limited to Generative Pre-trained Transformer (GPT) 4. The API layer 306 can also comprise a proxy 330 to a project management tool (via a project management tool API 328). By way of some examples, the API layer 306 can comprise one or more proxies 330 to one or more project management tools such as Jira™, Monday.com™, Clickup™, GitHub™, Asana™, and the like. An internal (database fetching) interface 332 can further be provided for extracting and storing data from the database layer 308.

In some embodiments, the front end module 310 comprises a behavioral insights module 334 for providing behavioral insights to the end user through the client device 104 and a backlog prioritization module 336 for prioritization of the tasks (in the form of e.g., tickets) to be provided to the end user.

Each of these components 311 to 336 may be implemented as separate modules. Alternatively, an ensemble of at least some of these components 311 to 336 may be integrated and implemented together to collectively provide the functions described herein. It should also be understood that the connections between the various modules 304-336 are not restrictive. For example, the proxy 330 may communicate directly with the database layer, e.g., project management database 320, to retrieve and store data directly.

In some embodiments, the behavior analytics module 304 can extract log data 302 from one or more data sources, such as a Salesforce™ event log data stream and/or other digital product event log data sources. The extracted log data may be stored in a storage 311, such as cloud storage, for use in the process mining. Other user data, including but not limited to user ID and data related to the LOB, can also be retrieved (e.g., from the user profile database 318) to be used together with the extracted log data for process mining.

In some embodiments, the extracted log data and the user data can undergo a data process pipeline 312 for data cleaning before input into the process mining module 314. For example, log files (e.g., csv files) containing log data as well as user data can be organized into a data structure suitable for process mining. In some implementations, the data can be loaded into Pandas data frames using Python™. The files can be merged on user IDs so each row of data can be categorized by its corresponding LOB. Thereafter the necessary columns for process mining (e.g., case ID, activity, timestamp and cost) can be extracted into data frames for each of some or all of the LOBs. The cleaned data can be fed into the process mining module 314.

The process mining module 314 embodies a first ML model which leverages process mining to process log data in order to produce insights. More specifically, the process mining module 314 utilizes a data mining technique for driving user behaviors out of event data and provides a visual path representing user behaviors from log in to log off. In some examples, the process mining module 314 is implemented utilizing a pm4py library which is a Python™ package for analyzing process data and generating visual graphs.

In some embodiments, the behavioral analytics module 304 may comprise alternative or additional data cleaning and/or transformation submodules, such as using Apache Airflow™ to perform event selection and event merging in addition to data cleaning. The intermediate results from the data cleaning/transformation can also be stored in a data warehouse using e.g., Snowflake™. The process mining module 314 may further leverage other data processing engine(s) or platform(s) such as Apache Spark™.

According to one exemplary implementation, user behavior patterns may be derived from the log data 302 using a get_variants function of the pm4py library, where the ‘variants’ represent the different paths a user may take, i.e. what page they visit, and in what order. The average duration each variant takes may be found using the ‘cost’ column, which in this case represents the duration of time in milliseconds.

For each LOB, the process mining module 314 may preserve a predetermined number of paths that have occurred the most times in a data frame, in order to simplify the graphing process. For example, the generated graphs can be based on a predetermined number (e.g., 75) of top paths that have occurred the most times in a data frame.

Various functions of the pm4py library can be used to create graphs for each LOB, including but not limited to petri net, business process notation model (BPMN), process tree, directly flows graph (DFG) and/or heuristic net.

Alternatively or additionally, to determine seasonal trends (e.g. daily and weekly activity trends) the day of the week and hour can be derived from the timestamp, and then converted into local time (for example, converting coordinated universal time (UTC) to eastern time (EST)) to identify hours or days with higher traffic.

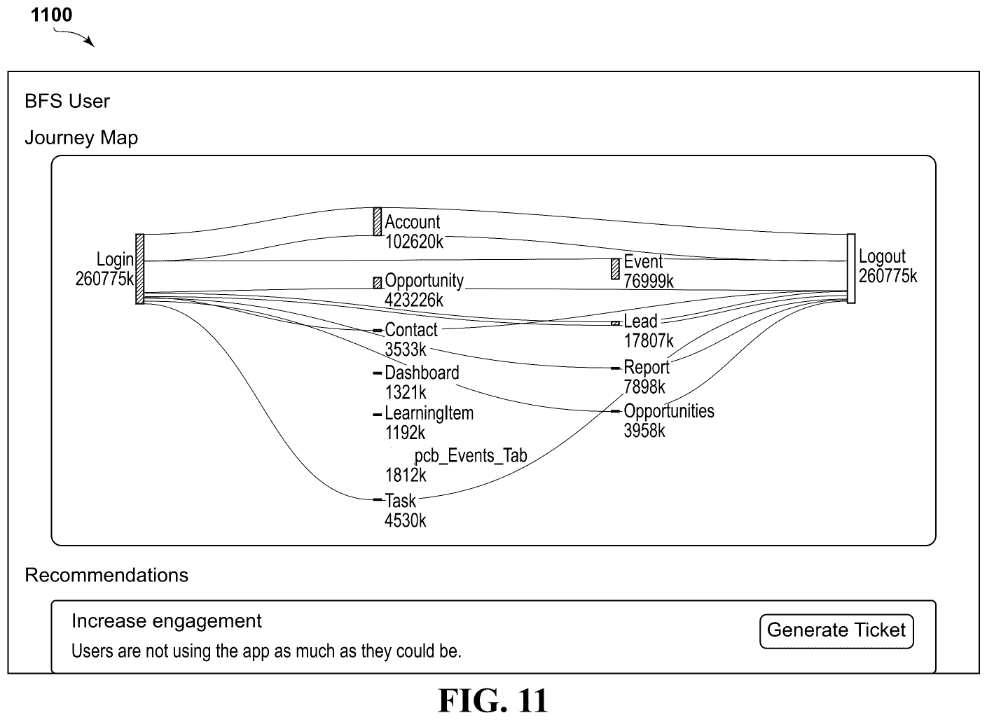

In some embodiments, the process mining module 314 further adjusts the formats of the graphs to better suit users' needs. For example, graphs can be generated in these embodiments in the form of Sankey diagrams instead of spaghetti graphs, to emphasize flow/movement/change from one state to another, thereby improving the user experience. FIG. 11 shows an example of a user interface providing the behavior path in a Sankey diagram.

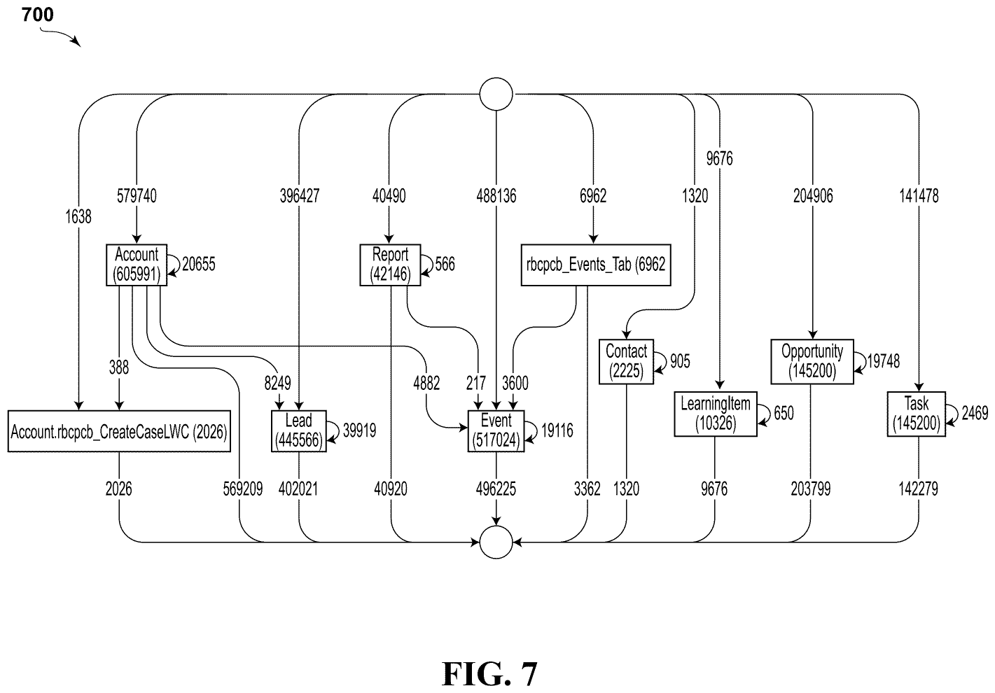

The behavioral graphs generated as a result of the processing mining can be stored in the database layer 308, e.g. the behavioral graph database 322. FIG. 7 provides an example of an output graph 700 of the process mining. Each note may represent a user behavior (e.g., page name) and each edge may be labelled with the number of users following a specific path. The graph provides a visual path representing the different paths a user may take for the different user flows.

According to one aspect of this disclosure, the computer network system 100 further converts the generated graphs into semantic mathematical representations as input into a second ML model. For example, the behavioral insights module 334 can translate the behavioral graphs into semantic search for the second ML model.

In some embodiments, the resulting graphs from the process mining can be encoded into JavaScript™ object notation (JSON) format where node names representing e.g., page names and edges labelled with the number of users following a specific path are described. Prompt engineering may be performed to specify certain areas for the second ML model to explore such as bottlenecks, pain points, issues, most frequent paths, dead clicks and the like.

In some embodiments, the computer network system 100 utilizes an external ML engine (such as the LLM engine described above) for providing the second ML model. The prompts generated by prompt engineering are input to the LLM engine and the LLM engine processes the translated representations to identify bottlenecks and pain points and the like to generate one or more insights in plain language (e.g., in words) as one or more recommendations to provide to the product management team.

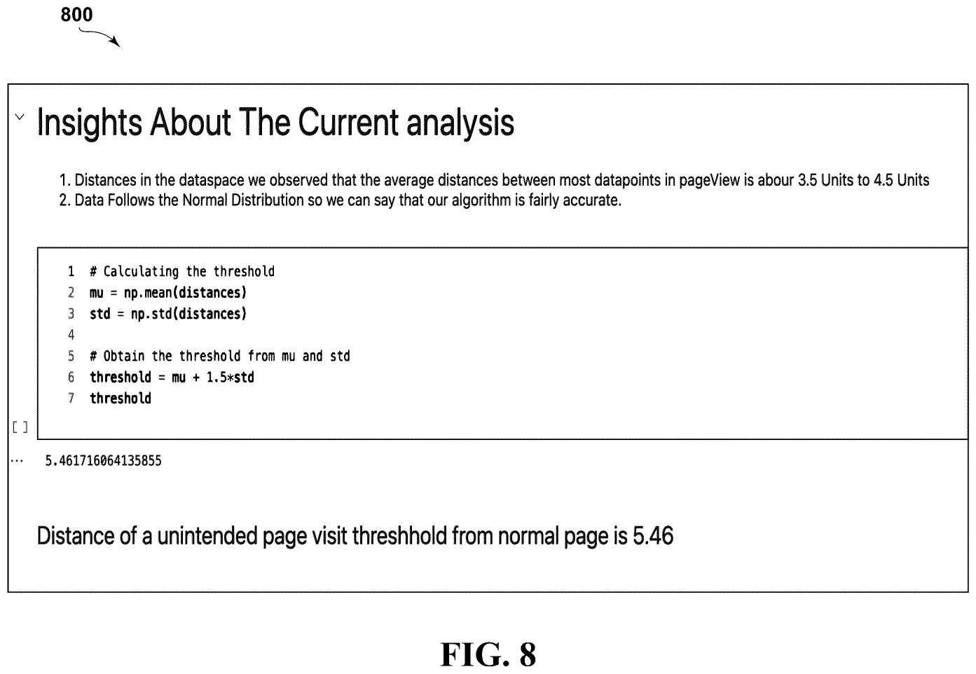

By way of an example, an insight can be generated in plain language that informs the most efficient way to navigate through the pages, which parts of the page are used by the user, or the like. The insights can be used by the team to compare to the existing process to customize the platform in a way the user would prefer. FIG. 8 shows an example of an insight 800 generated by the behavioral insights module 334. In this example, the results show that a distance of an unintended page visit threshold from a normal page is 5.46 pages.

In some embodiments, the prompts are iterated to refine the LLM's performance to achieve higher quality insights, depending on the needs of the teams.

According to one aspect of this disclosure, the computer network system 100 also integrates insights and recommendations with at least one project management tool to ensure seamless transition from recommendation to team's workflow.

In some embodiments, the computer network system 100 provides an API proxy 330 to integrate with an external project management tool (e.g., Jira™). For example, the generated insights can be populated as a ticket's metadata to be sent to a team's backlog, using e.g., a Jira™ REST API.

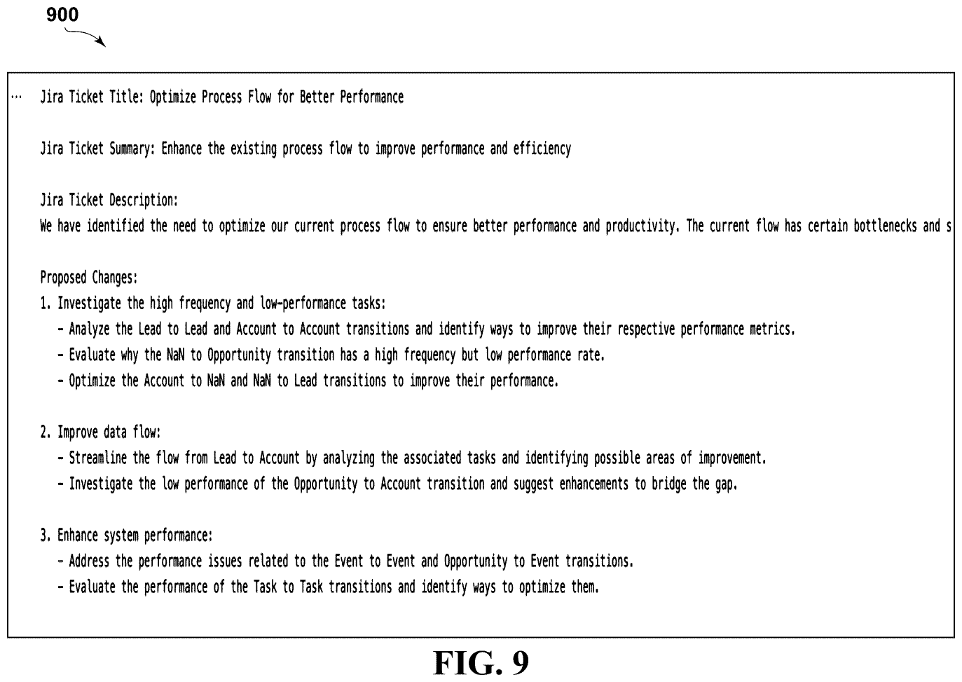

In these embodiments, the results from the LLM engine can be populated as tickets onto a ticket board. The LLM engine can also be exposed to previous tickets from the team, for it to gain context of the team's work, and any specific language the teams use, so that the LLM can refine the language of the generated insights to be in line with the language of the team's previous tickets or tasks. FIG. 9 shows an example of the results 900 generated by the LLM. The results provide a description of the ticket and recommendations of proposed changes for the team.

In many applications of the product management teams, tickets or tasks can get lengthy where important issues can get lost, or not completed or addressed in a timely manner. According to another aspect of this disclosure, the computer network system 100 provides backlog prioritization for prioritizing the tasks or tickets to facilitate the teams to make strategic decisions, utilizing a classification ML model.

In some embodiments, the tickets' names (e.g., Jira™ Epic names) are compared to the insights generated by the LLM from the process mining diagrams to prioritize the backlog. A score can be assigned based on a number of matched key words (e.g., key words matched with the insights that are not stop words such as ‘and’ or ‘the’) contained in each ticket. The score of the ticket generally correlates to the rank in the prioritization of the tickets, such that the higher the score, the higher the ranking of the ticket can be. The tickets can then be categorized into different categories, including for example, high priority, medium priority, and/or low priority, or the like.

In some embodiments, the backlog prioritization utilizes a classification ML model trained on event log data 302 to learn what tickets are most important and/or should be prioritized. The classification ML model can be implemented using the LLM engine described above, or through other ML engine(s).

While the various embodiments make specific reference to Jira™ and Jira™ tickets, it should be understood that the computer network system 100 can integrate with other project management tool(s) for managing tasks for the teams. Further, the API layer 306 may further utilize one or more integration tool(s) such as LANGCHAIN™ to facilitate integration of the LLM (or other ML models) and/or the project management tool(s). The integration tool(s) can communicate with the LLM(s), the project management tool(s), and/or the database(s) to facilitate the integration.

As described above, the computer network system 100 uses one or more ML engines and models to integrate with one or more of the processes of processing mining, insights generation, and/or backlog prioritization. It should be understood that some or all of the above-described ML engines may be separate ML engines or a same ML engine. Further, while the description makes specific reference to an external ML engine such as GPT 4, other external or internal ML engines may be used.

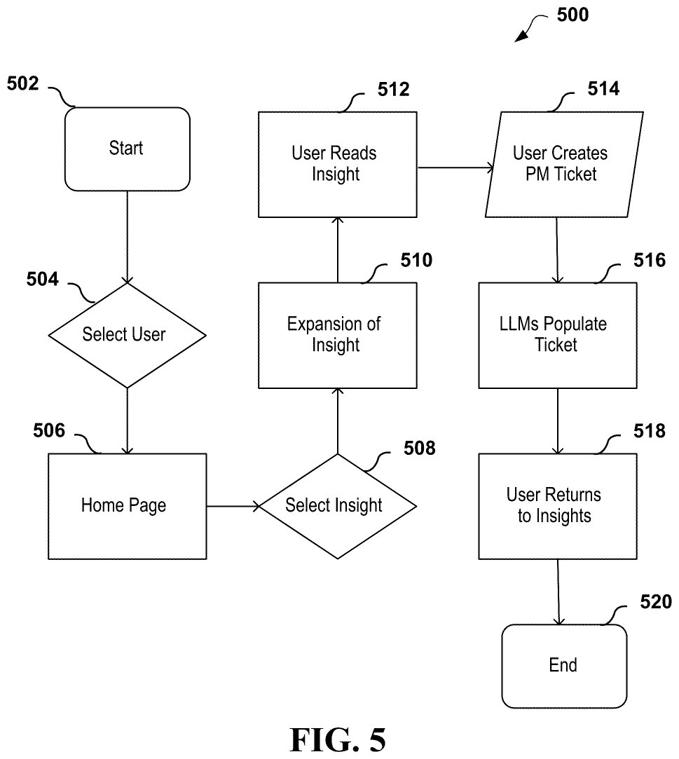

FIG. 4 is a process flow diagram 400 of the computer network system 100, according to some embodiments of this disclosure.

A user at the client end 312 may log into the system through a related web application. Based on the user ID or a selected user type, the system can present the user with one or more of generated insights from the insights data store 408, recommendations 404 and/or backlog prioritization 406 relating to the specific user type.

When the client logs in or selects the user type, insights related to that specific user type can be displayed. By way of an example, the insights can be displayed based on user categories including BFS, retail, advice center, contact center and the like. The system may comprise an ML pipeline running periodically (such as daily) to ingest new data, process them, and then mine insights from the logs that run that day as described above. The generated insights can be saved to the insight database 408 which the front end modules 334, 336 can later access.

According to one aspect of the disclosure, the computer network system 100 can provide insights in the form of recommendations 404 to the user for action items that a team can take. In some embodiments, the system can provide an option to present the action items in the form of tickets (e.g., Jira tickets) through the team ticket board 412 based on insights that are generated through process mining. The fields of the tickets can be generated by a ticket generator 410. The ticket generator 410 leverages the LLM and receives the product team's current ticket description, summary, title standards as context from the team ticket board 412 to be better informed with the appropriate tickets to be generated. The process can involve a Retrieval Augmented Generation (RAG) implementation where the prompt engineering provides prompts that can inform the LLM of context about the unique data set (e.g., how the team writes their ticket issues), thereby allowing the LLM to generate recommendations in a similar style based on the insights.

In some embodiments, the computer network system 100 can provide a reinforcement learning function to customize the LLM to generate more topical insights based on the user's preference by tracking user interactions. For example, a user usually clicks ‘More Information’ on insights relating to bottlenecks, so the LLM can learn to generate more insights involving bottlenecks.

According to one aspect of the disclosure, the computer network system 100 can also provide backlog prioritization 406 to the user. For example, when the user navigates to the prioritization page through a user selection 402, this can trigger the backend modules of the computer network system 100 to fetch the ticketed issues and pass them into the classification ML model 414 to provide a ranking of the backlog issues or tickets. The ranked issues/tickets can be then displayed to the user. In some embodiments, the backlog prioritization 406 can retrieve ticket information from the team ticket board 412 and send them to the classification ML model 414 to train the classification ML model 414 to learn what tickets are most important and/or should be prioritized. The classification ML model 414 can return the ranking of the backlog issues or tickets to the backlog prioritization 406 to be provided to the user for selection and/or action.

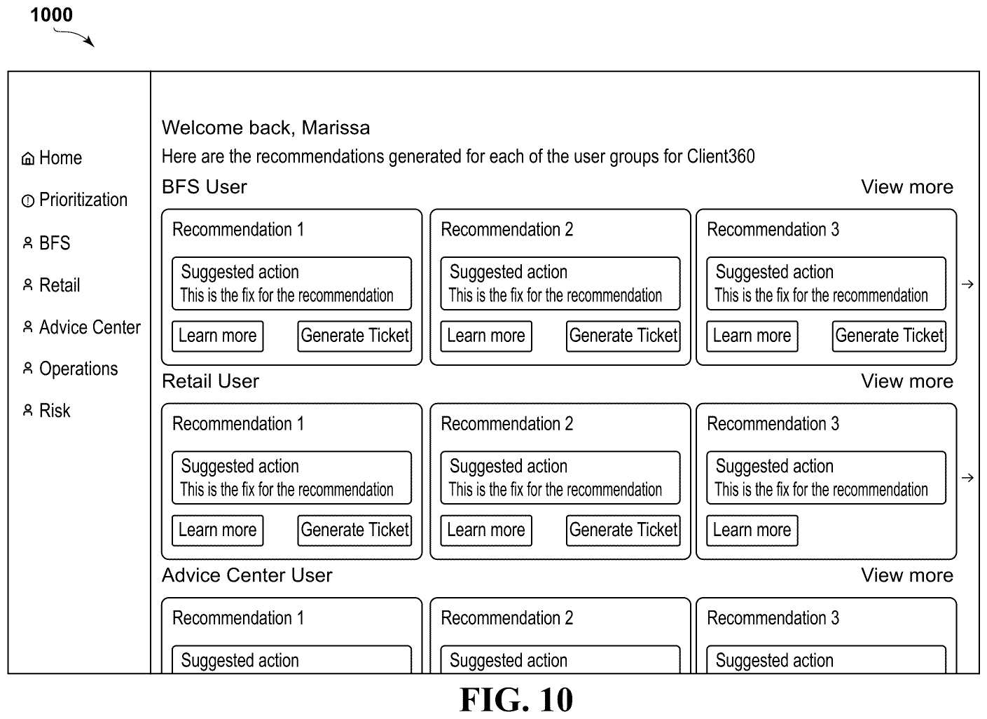

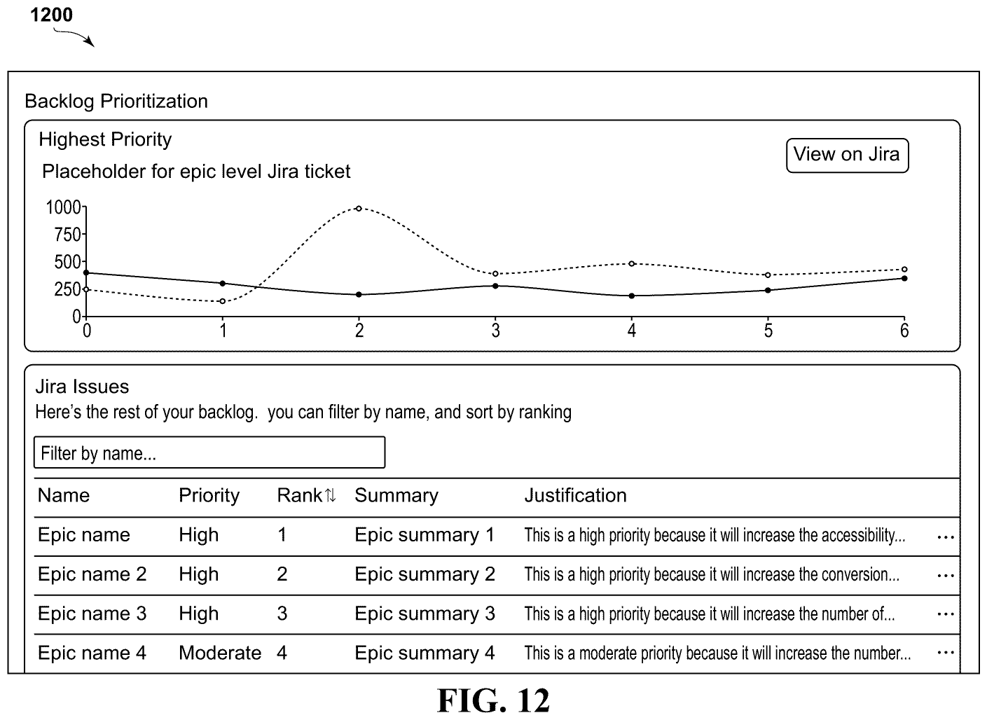

FIG. 10 is a screenshot showing an example of a user interface 1000 providing insights/recommendations with options to generate tickets; FIG. 11 is an example of a user interface 1100 providing a graph of the behavior path with related insights/recommendations; and FIG. 12 is an example of a user interface 1200 providing backlog prioritization. The user interface 1200 provides a list of prioritized tickets in terms of their priority ranking.

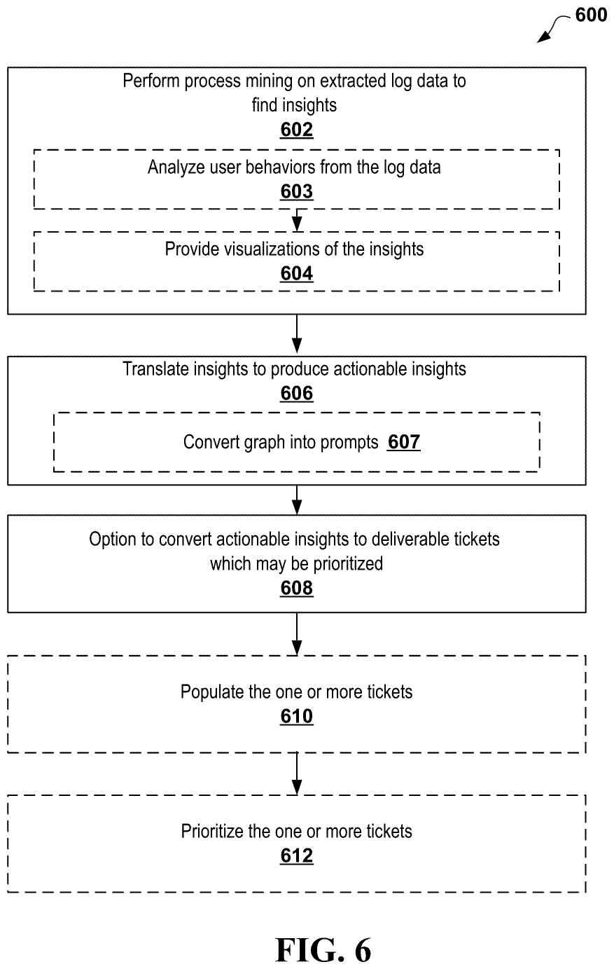

Referring now to FIG. 5, a user flow diagram (500) at the user end 104 is provided showing the steps of how a user interacts with the system.

The process can start (502) with the user entering the platform (e.g., through the web application) and the user can select (504) or otherwise the system can identify their associated user type (e.g., business group). A home page is then populated (506) with personalized content in relation to the user type. When a desired insight is selected (508), it can be expanded (510) to display more information for review by the user. Upon the user reviewing (512) the insights, the user can create (514) a project management ticket (e.g., Jira™ ticket) through the insight (see for example, FIG. 10) where the fields of the ticket can be automatically populated (516) using the integrated LLM. The user can either return (518) to the home page to view the remaining insights or leave the platform to review the ticket that is created. The process ends at step (520).

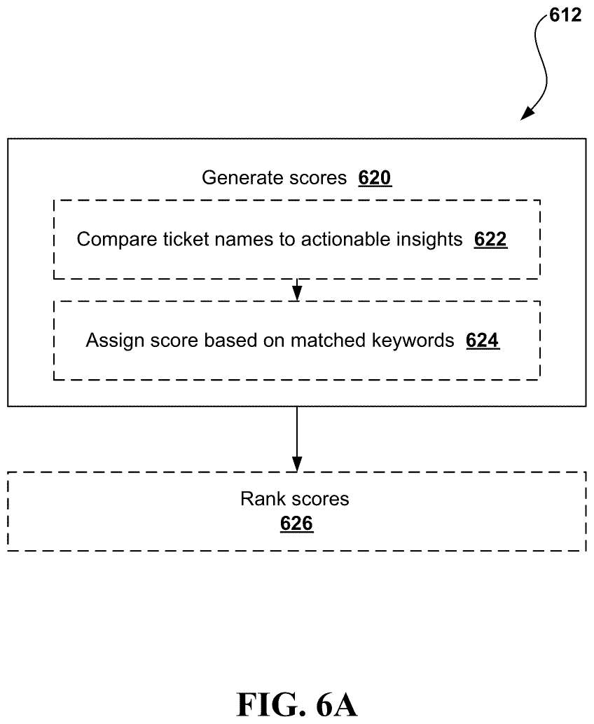

FIG. 6 is a flowchart showing a process (600) performed by the computer network system, according to some embodiments of this disclosure.

The process (600) comprises performing (602) process mining on extracted log data to find insights. More specifically, the process (600) can extract the log data from one or more preferred data source and feed the log data together with user data to the process mining module embodying a first ML model to find insights from the log data.

The process (600) may use a pm4py library to analyze (603) user behaviors from the user log data and develop (604) visualizations from the insights, for the users to monitor the insights and key performance indicators in real time. For example, the process can provide to the user one or more behavior paths in Sankey diagrams representing flows between user behaviors.

The results (e.g., graphs) from the process mining are translated (606) to produce actionable insights. As described above, the behavioral graphs can be translated (607) into semantic search and prompted (through prompts) to an LLM gateway in order to produce the actionable insights.

The process also provides (608) an option to convert the actionable insights into one or more deliverable tickets for a product management team (e.g., Jira™ tickets). The tickets can be transported to a ticket board (e.g., Jira™ board) by leveraging an API to the project management tool (Jira™). The deliverable tickets may also be prioritized using a classification ML model as described.

In some embodiments, the process may populate (610) tickets based on a machine learning model trained on previous tickets generated by the product management team, upon user selection to convert the actionable insights into tickets. This process may be implemented through a RAG implementation.

In some embodiments, the process may further comprise prioritizing (612) the one or more tickets for the product management team using a classification machine learning model.

FIG. 6A is a flowchart showing a process (612) of prioritizing the one or more tickets, according to some embodiments of this disclosure.

The process (612) can comprise generating (620) a score associated with each ticket; and ranking (626) the tickets based on their generated scores. In some embodiments, the score associated with each ticket may be generated by comparing (622) ticket names to the generated actionable insights; and assigning (624) the score to each ticket based on a number of matched keywords contained in each ticket, wherein the matched keywords comprise words that match with the actionable insights and exclude stop words.

The methods described herein may be performed by a particular server 108 or collectively by multiple servers 108 in the data center 106 and/or by multiple data centers 106.

The various embodiments of the computer network system 100 provide the end user with at least one or more of the following functionalities:

User Behaviour Insights can be generated from log data 302 and provided to the user. User behavior insights can be generated relating to specific user types (e.g., LOBs), such as providing separate insights for user flows for e.g., retail, BFS, Organizational Change Management (OCM), and/or mortgage specialist user types. This can provide helpful and actionable information for the related teams to understand the specific behaviors relating to different user types. For example, 15% of retail users go through the drop down menu, find the client, and then create an opportunity/lead; while only 12% of BFS users follow this flow. The insights can be concise but if desired they can be expanded to display more detailed information. Updated statistics may be highlighted.

Personalization can be provided based on which user group the user is related to (i.e. Retail, OCM, etc.). The foremost insights will revolve around the user type, therefore, showing the most relevant information for the associated category. All remaining insights can still be accessible.

Backlog Prioritization (using a classification model) can be provided which consolidates the insights and arranges them based on priority (e.g., high, moderate, and low). A description may also be offered of the model's reasoning for the insight's priority.

Project Management Tool Integration (leveraging LLM) is provided which allows users to convert insights into tickets within the project management tool. For the product management team, they can create tickets (such as Epic Jira™ tickets when they work at a Jira™ Epic level) to determine the initiatives that should be prioritized going forward. Because the tickets can be prioritized, a select few of the tickets can be focused on based on capacity and urgency. Having a pipeline to create tickets for the most prevalent insights directly simplifies the process. Additionally, the use of LLM which helps populate the information needed for the ticket can further simplify the process. Constraints to the number of tickets created per user can be created depending on the specific implementation.

The computer network system 100 may further provides an ability to search for key performance indicators (KPIs) and insights, and/or an ability to forecast potential monetary impact if the insight is implemented or not implemented.

The various embodiments described herein therefore provide a centralized, integrated pipeline that takes log data and transforms it into actionable insights that can be directedly generated into tickets.

The various embodiments described herein use graphs generated from process mining to produce actionable insights using at least one LLM. These actionable insights can be directly populated into an integrated project management tool, streamlining the product management process. Additionally, a team's tickets backlog can be prioritized using a classification model trained on event log data to give the team a data driven perspective on what is imperative to their future sprints.

The various embodiments described herein leverage one or more machine learning technologies to provide information and actionable items easy to use for users of all backgrounds. The system integrates process mining, one or more machine learning models, and at least one project management tool to deliver a secure solution that derives actionable insights from otherwise uninterpretable log data.

This provides tremendous improvement on computer efficiency compared to conventional methods where end users would have to conduct process mining on the data logs, and then learn and analyze the graph themselves, before finally distilling all the findings into an insight and creating a corresponding ticket. Additionally, no existing solutions are known to prioritize the backlog or to address the issue of lengthy task list the team faces.

The various embodiments described herein can provide significant technological improvements in computer-based process mining and actionable insight generation. Specifically, the system implements a data processing pipeline that performs process mining on large volumes of user log data. This automated analysis extracts valuable behavioral patterns and insights that would be impractical to derive manually. The process mining results can then be translated into actionable insights using a machine learning engine. This represents an application of machine learning to interpret complex process data and generate practical recommendations.

The system further provides an interface that allows users to convert abstract insights directly into concrete product management tickets. This creates a seamless workflow from data analysis to actionable tasks.

A classification machine learning model may be employed to intelligently prioritize the generated tickets. This can automate a typically manual and subjective process, improving efficiency and consistency.

The system generates specialized visualizations like behavior path diagrams and backlog prioritization graphs. These custom visual analytics tools enable more intuitive understanding of complex user behavior data.

Reinforcement learning techniques are utilized to continuously refine and customize the generated insights based on user interactions. This creates an adaptive system that improves its recommendations over time.

The combination of process mining, machine learning-based insight generation, automated ticketing, and adaptive refinement represents a novel technical solution for deriving actionable product improvements from raw user log data. This integrated approach can significantly enhance the speed, accuracy, and/or utility of user behavior analysis compared to conventional manual methods.

The embodiments have been described above with reference to flow, sequence, and block diagrams of methods, apparatuses, systems, and computer program products. In this regard, the depicted flow, sequence, and block diagrams illustrate the architecture, functionality, and operation of implementations of various embodiments. For instance, each block of the flow and block diagrams and operation in the sequence diagrams may represent a module, segment, or portion of code, which comprises one or more executable instructions for implementing the specified action(s). In some alternative embodiments, the action(s) noted in that block or operation may occur out of the order noted in those figures. For example, two blocks or operations shown in succession may, in some embodiments, be executed substantially concurrently, or the blocks or operations may sometimes be executed in the reverse order, depending upon the functionality involved. Some specific examples of the foregoing have been noted above but those noted examples are not necessarily the only examples. Each block of the flow and block diagrams and operation of the sequence diagrams, and combinations of those blocks and operations, may be implemented by special purpose hardware-based systems that perform the specified functions or acts, or combinations of special purpose hardware and computer instructions.

The terminology used herein is for the purpose of describing particular embodiments only and is not intended to be limiting. Accordingly, as used herein, the singular forms “a”, “an”, and “the” are intended to include the plural forms as well, unless the context clearly indicates otherwise (e.g., a reference in the claims to “a challenge” or “the challenge” does not exclude embodiments in which multiple challenges are used). It will be further understood that the terms “comprises” and “comprising”, when used in this specification, specify the presence of one or more stated features, integers, steps, operations, elements, and components, but do not preclude the presence or addition of one or more other features, integers, steps, operations, elements, components, and groups. Directional terms such as “top”, “bottom”, “upwards”, “downwards”, “vertically”, and “laterally” are used in the following description for the purpose of providing relative reference only, and are not intended to suggest any limitations on how any article is to be positioned during use, or to be mounted in an assembly or relative to an environment. Additionally, the term “connect” and variants of it such as “connected”, “connects”, and “connecting” as used in this description are intended to include indirect and direct connections unless otherwise indicated. For example, if a first device is connected to a second device, that coupling may be through a direct connection or through an indirect connection via other devices and connections. Similarly, if the first device is communicatively connected to the second device, communication may be through a direct connection or through an indirect connection via other devices and connections. The term “and/or” as used herein in conjunction with a list means any one or more items from that list. For example, “A, B, and/or C” means “any one or more of A, B, and C”.

It is contemplated that any part of any aspect or embodiment discussed in this specification can be implemented or combined with any part of any other aspect or embodiment discussed in this specification.

The scope of the claims should not be limited by the embodiments set forth in the above examples, but should be given the broadest interpretation consistent with the description as a whole.

It should be recognized that features and aspects of the various examples provided above can be combined into further examples that also fall within the scope of the present disclosure. In addition, the figures are not to scale and may have size and shape exaggerated for illustrative purposes.

What is claimed is:

1. A computerized method comprising:
performing process mining on user log data;
translating results of the process mining into actionable insights using a machine learning engine; and
providing an option to convert the actionable insights into one or more tickets for a product management team.

2. The computerized method of claim 1, further comprising prioritizing the one or more tickets for the product management team using a classification machine learning model.

3. The computerized method of claim 2, wherein said prioritizing the one or more tickets comprises:
generating a score associated with each of the one or more tickets; and
ranking the one or more tickets based on their generated scores.

4. The computerized method of claim 3, wherein said generating a score associated with each of the one or more tickets comprises:
comparing names of the one or more tickets to the generated actionable insights; and
assigning the score to each ticket based on a number of matched keywords contained in each ticket, wherein the matched keywords comprise words that match with the actionable insights and exclude stop words.

5. The computerized method of claim 1, wherein said translating results of the process mining into actionable insights using a machine learning engine comprises converting a graph generated by the process mining into prompts for the machine learning engine.

6. The computerized method of claim 5, wherein the graph comprises a Sankey diagram representing flows between user behaviors.

7. The computerized method of claim 1, wherein said performing process mining on user log data comprises using a pm4py library to analyze user behaviors from the user log data to create a graph.

8. The computerized method of claim 1, further comprising: upon user selection to convert the actionable insights into the one or more tickets, populating the one or more tickets based on a machine learning model trained on previous tickets generated by the product management team.

9. The computerized method of claim 8, wherein said populating the one or more tickets comprises a Retrieval Augmented Generation (RAG) implementation.

10. A system comprising:
one or more processors; and
one or more non-transitory computer-readable storage media functionally coupled to the one or more processors and storing instructions that, when executed, cause the one or more processors to:
perform process mining on user log data;
translate results of the process mining into actionable insights using a machine learning engine; and
provide an option to convert the actionable insights into one or more tickets for a product management team.

11. The system of claim 10, wherein the instructions further cause the one or more processors to prioritize the one or more tickets for the product management team using a classification machine learning model.

12. The system of claim 11, wherein said prioritizing the one or more tickets comprises:
generating a score associated with each of the one or more tickets; and
ranking the one or more tickets based on their generated scores.

13. The system of claim 12, wherein said generating a score associated with each of the one or more tickets comprises:
comparing names of the one or more tickets to the generated actionable insights; and
assigning the score to each ticket based on a number of matched keywords contained in each ticket, wherein the matched keywords comprise words that match with the actionable insights and exclude stop words.

14. The system of claim 10, wherein said translating results of the process mining into actionable insights using a machine learning engine comprises converting a graph generated by the process mining into prompts for the machine learning engine.

15. The system of claim 14, wherein the graph comprises a Sankey diagram representing flows between user behaviors.

16. The system of claim 10, wherein said performing process mining on user log data comprises using a pm4py library to analyze user behaviors from the user log data to create a graph.

17. The system of claim 10, wherein the operations further cause the one or more processors to: upon user selection to convert the actionable insights into the one or more tickets, populate the one or more tickets based on a machine learning model trained on previous tickets generated by the product management team.

18. The system of claim 17, wherein said populating the one or more tickets comprises a Retrieval Augmented Generation (RAG) implementation.

19. A non-transitory computer-readable storage medium storing instructions that, when executed by one or more processors, cause the one or more processors to perform operations comprising:
performing process mining on user log data;
translating results of the process mining into actionable insights using a machine learning engine; and
providing an option to convert the actionable insights into one or more tickets for a product management team.

20. The non-transitory computer-readable storage medium of claim 19, wherein the operations further cause the one or more processors to prioritize the one or more tickets for the product management team using a classification machine learning model.
